(19) United States
(12) Patent Application Publication
(10) Pub. No.: US 2009/0134761 A1
(43) Pub. Date: May 28, 2009

(54) GAS DISCHARGE LAMP HAVING A COLD SPOT OUTSIDE ITS TRANSLUCENT ENVELOPE

(75) Inventors: Rene J. Hendriks, Eindhoven (NL); Cornelis Versluijs, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/577,934

(22) PCT Filed: Oct. 24, 2005
(86) PCT No.: PCT/IB05/53481

§ 371 Date: Apr. 25, 2007

(30) Foreign Application Priority Data
Oct. 26, 2004 (EP) 04105299.4

(51) Int. Cl. H01J 61/52

(52) U.S. Cl. 313/46

(57) ABSTRACT

A gas discharge lamp having an envelope (1, 3) comprising a translucent cylindrical part (1) and an end part (3) at each end of said cylindrical parts (1). Lead wires (4, 5) supply electric current to an electrode (6) near each of said end parts (3) and extend through the material of each of the two end parts (3). At least one end part (3) is provided with a tubular element (7) made of a thermally conductive material, such as a metal or a thermally conductive ceramic material, that extends through the material of said end part (3), such that an open end of said tubular element (7) is connected to the space inside the envelope (1, 3) and a closed end of the tubular element (7) extends outside the envelope 1,3).

The invention relates to a gas discharge lamp having an envelope comprising a translucent cylindrical part and an end part at each end of said cylindrical part, lead wires for supplying electric current to an electrode near each of said end parts extending through the material of each of the two end parts.

In particular, the lamp is a low-pressure mercury vapor discharge lamp whose cylindrical part is made of translucent or transparent glass. The translucent cylindrical part may be straight over its entire length. However, the cylindrical part may alternatively comprise one or more curves, even through an angle of 180°, such that at least the two ends of the cylindrical part, near said end parts, are straight cylinders. The cylindrical part of the envelope of the lamp and one or both end parts may be formed out of one piece of material, such as glass, but in general the end part, or stem, is attached to the cylindrical part by means of an adhesive or frit in order to seal the two parts together in a gastight manner.

Such a gas discharge lamp is described in JP-A-02177246, wherein the end parts are disc-shaped members formed of glass, the edge of each disc-shaped member is connected to the circular edge of the translucent cylindrical part by means of frit glass, which is heated and subsequently cooled down in order to interconnect the two parts. The lead wires for supplying electric current to the electrode together with the electrode itself are attached to the end part before the sealing operation takes place.

Inside the envelope of a gas discharge lamp there is a location where the temperature is relatively low during operation of the lamp, i.e. lower than in other locations in the envelope, so that a certain gas in the lamp, in particular mercury, will condensate in that location. Such a location is called the cold spot of the lamp. This condensation at the cold spot maintains the quantity of the relevant gas in the envelope, in particular mercury, at a desired, predetermined level.

In the lamp as described above, the cold spot may be located somewhere in the middle of the envelope, i.e. between the two electrodes, but often it is located near one of the end parts of the envelope of the lamp. The light emission is less in the cold spot than in other locations of the envelope, and therefore a cold spot near one of the end parts is generally preferred. It may be desired, however, that the light emission is substantially equal over the entire length of the envelope of the lamp up to the ends of the envelope, in particular if the gas discharge lamp is to be used for back lighting, and furthermore, the total length of the lamp should not be much greater than the length of the light-emitting envelope. The presence of the cold spot may disturb the equal distribution of the light emission along the length of the envelope of the lamp.

In order to maintain the cold spot within the desired temperature range, it may be required to force the temperature of the cold spot to a lower level, for example by making use of heat-conducting means for guiding heat away from the cold spot.

The object of the invention is to provide a gas discharge lamp having an envelope comprising a translucent cylindrical part and an end part at each end of said cylindrical part, wherein the cold spot does not disturb the substantially equal distribution of the light emission along the entire length of the envelope of the lamp, wherein an adequate cooling of the cold spot is possible, and wherein, preferably, the length of the total lamp is not much greater than the length of the light-emitting envelope.

To accomplish said object, at least one end part of the envelope is provided with a tubular element made of a thermally conductive material, such as a metal or a thermally conductive ceramic material, extending through the material of said end part, an open end of said tubular element being connected to the space inside the envelope and a closed end of the tubular element extending outside the envelope. The cold spot of the lamp will thus be located in the tubular element near the closed end thereof, because the location is relatively far away from the gas discharge in the envelope. Furthermore, the end of the tubular element that extends to outside the envelope will be subjected to cooling by convection of the air around the tubular element. In addition, heat from inside the tubular element can be readily transported to the outer surface of the tubular element due to the thermally conductive material. Furthermore, the metal tubular element can easily be closed by a soldering operation or by deformation of the material. In principle, it is even possible to use the tubular element as one of the two lead wires extending through the material of the relevant end part of the envelope.

Furthermore, the tubular element may be used to fill the envelope with the required gas before the tubular element is closed at one of its ends. In order to fill the envelope with the appropriate gas mixture, firstly air can be sucked out of the envelope through the tubular element and subsequently the required gas mixture can be pumped into the envelope through the tubular element, and afterwards the outer end of the tubular element can be closed.

There may be two openings, one at each end of the envelope, for filling the envelope with the appropriate gas mixture. The appropriate gas mixture can be pumped into the envelope at one end in that case, while the air escapes at the other end of the envelope. Both openings must be closed afterwards in this arrangement.

In one preferred embodiment, the tubular element is curved, so that said closed end thereof is positioned at an angle to the axial direction of said cylindrical part of the envelope, preferably an angle of about 90°. The total length of the lamp is decreased thereby, while the desired length of the tubular element can be maintained. For certain applications of the lamp, in particular for backlighting in a liquid crystal display (LCD), it is important that the light emission from the lamp is equally distributed over the entire length of the lamp and that the length of the lamp is not much greater than the length of the light-emitting envelope.

In order to decrease the temperature of the cold spot, preferably, a heat sink located outside the envelope is connected to said tubular element. Such a heat sink may comprise black metal surfaces, so that the heat can be removed from the tubular element by heat radiation.

In one preferred embodiment, at least one end part of the envelope is a disc-shaped member, the edge of the disc-shaped member is connected to the circular edge of the translucent cylindrical part of the envelope. Thereby the less light emitting end portion of the lamp can be short, because of the limited length of the disc-shaped member in axial direction of the lamp. Furthermore, it is relatively simple to mount the tubular element in a bore in the disc-shaped member, because of its flat shape.

In one preferred embodiment, a shield is present inside the envelope between at least a portion of the electrode and the open end of the tubular element, which shield is attached to said end part near the electrode, or to one or both lead wires. The shield will avoid heat radiation from the electrode to the tubular element. In particular when the material of the tubular element is metal, any heating-up of the open end of the tubular element should be minimized in order to obtain a low temperature in the cold spot, in particular if the tubular element is short.

Preferably, the shield substantially encloses the electrode, and, preferably, the material of the shield is metal or in an alternative preferred embodiment a ceramic material, and, preferably, the shield is provided with a light-reflecting surface at its side facing the electrode, and/or a surface providing minimal heat radiation at the other side. A shield having the shape of a cylindrical wall surrounding the electrode reduces darkening of the cylindrical wall near the end of the envelope of the lamp. Said darkening is caused by evaporation or sputtering of material from the electrode during operation of the lamp and may reduce the light emission at the end of the envelope of the lamp.

The disc-shaped member may be made of glass. In one preferred embodiment, however, the disc-shaped member is made of metal, or, in another preferred embodiment, the disc-shaped member is made of glass-ceramic material. The disc-shaped member can be made relatively thin (short in axial direction) as a result of this, and the advantage of a glass- to the cylindrical part in a melting operation.

The invention will now be explained in more detail by means of a description of a gas discharge lamp having an envelope comprising a translucent cylindrical part and an end part at each end of said cylindrical part, where at least one end part is provided with a tubular element extending through the material of said end part, reference being made to the drawing comprising Figures, in which:

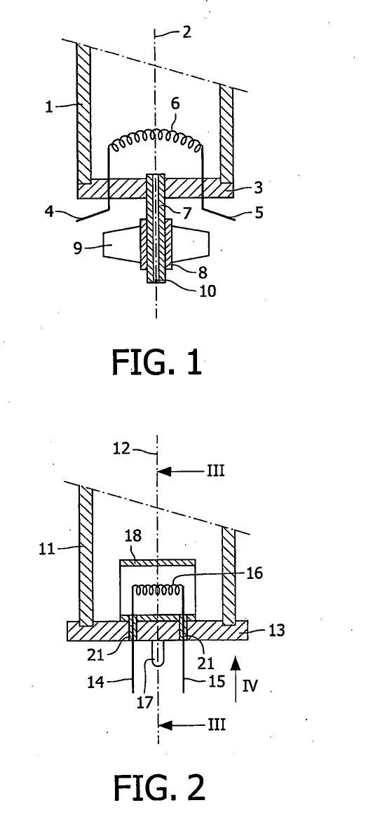

FIG. 1 is a sectional view of a first embodiment of a gas discharge lamp;

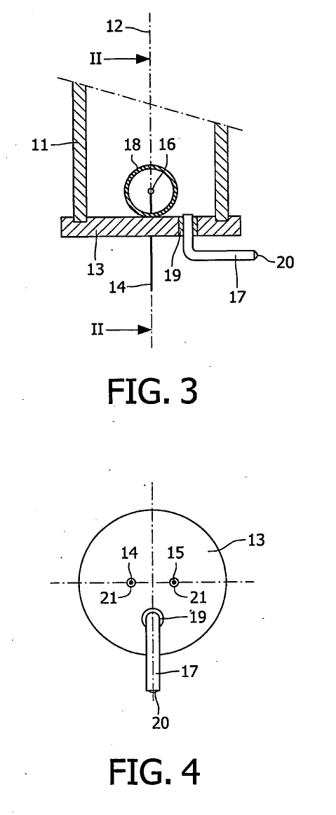

FIG. 2 is a sectional view of a second embodiment of a gas discharge lamp, taken along arrows II in FIG. 3;

FIG. 3 is another sectional view of the second embodiment taken along arrows III in FIG. 2, and

FIG. 4 shows the second embodiment viewed along arrow IV in FIG. 2.

The Figures are schematic representations, showing only the mutual relations of relevant parts of the gas discharge lamp in order to elucidate the invention.

FIG. 1 shows one end of a tubular mercury vapor discharge lamp according to the first embodiment. The end of a translucent cylindrical part 1, having an axis 2, is connected to a disc-shaped member 3 by means of an adhesive, so that a gastight envelope 1,3 is created. The material of the cylindrical part 1 is glass, and the disc-shaped member 3 (end part of the envelope) is made of glass-ceramic material. The diameter of the cylindrical part 1 may have any dimension, the diameter of the cylindrical part 1 represented in the drawing is relatively large, so that the different parts can be clearly shown. Two lead wires 4,5 extend through the disc-shaped member 3. The ends of the two lead wires 4,5 inside the envelope 1,3 are connected to the ends of an electrode 6 having a helical shape (i.e. being a coil). The ends of the two lead wires 4,5 outside the envelope 1,3 can be connected to an electric current source (not shown in the drawing) in order to supply electric current to the electrode 6.

A straight tubular element 7 is positioned coaxially with the cylindrical part 1 of the envelope 1,3 and extends through the disc-shaped member 3. A portion of the tubular element 7 extending outside the envelope 1,3, is surrounded by a heat sink 8 having a number of wings 9 provided with heat-radiating surfaces. The tubular element 7 is made of ceramic material and is fixed in a bore in the disc-shaped member 3 by means of an adhesive. The material of the heat sink 8,9 is a metal having a high thermal conductivity. The heat sink 8,9 is cooled down by convection of air around it and by radiation of heat from it. The heat sink 8,9 can thus cool down the portion of the tubular element 7 extending outside the envelope 1,3, so that the cold spot of the mercury vapor discharge lamp is necessarily located in the tubular element. The temperature of the cold spot of the lamp can be adjusted within a certain range in that the heat sink 8,9 is given appropriate dimensions and an appropriate shape. The optimal dimensions and shape of the heat sink 8,9 can be determined empirically.

During manufacture of the lamp, the envelope 1,3 must be filled with the appropriate gas mixture comprising mercury vapor. Therefore, after the envelope 1,3 has been manufactured, there must still be an opening to exhaust the air and to pump in the appropriate gas mixture. Such an opening is created by the central bore of the tubular element 7. After filling of the envelope 1,3, said central bore is closed by means of a drop 10 of adhesive material introduced into the opening of the bore outside the envelope 1,3.

There may be two openings, one at each end of the envelope 1,3, for the purpose of filling the envelope 1,3 with the appropriate gas mixture. The appropriate gas mixture can thus be pumped into the envelope 1,3 at one end while the air escapes at the other end of the envelope 1,3. In that case both openings must be closed afterwards.

FIGS. 2-4 show the second embodiment of a gas discharge lamp. In this embodiment the translucent cylindrical part 11 of the envelope of the lamp has a central axis 12. The cylindrical part 11 is connected to a disc-shaped member 13. The material of the cylindrical part 11 is glass and the disc-shaped member 13 is made of metal. The two parts 11,13 are attached to each other in a gastight manner by means of an adhesive. The metal of the disc-shaped member 13 and the glass of the cylindrical part 11 have the same coefficient of expansion in order to prevent them developing cracks during heating-up.

Two lead wires 14,15 reach through the disc-shaped member 13, and each of the two lead wires 14,15 connects an end of the electrode 16 inside the envelope 11,13 to an electric current source (not shown) outside the envelope 11,13 in order to supply electric current to the electrode 16. As is shown in FIGS. 2 and 3, a cylindrical wall 18 surrounds the electrode 6. The cylindrical wall 18 is made of metal and is welded to the disc-shaped member 13. The wall 18 forms a shield enclosing the coil-shaped electrode 6, the inner side of the wall 18 having a heat-reflecting surface, while the outer side has a surface that provides minimal heat radiation.

As shown in the FIGS. 2-4, a tubular element 17, i.e. a metal tube, extends through the disc-shaped member 13. FIG. 3 shows the tubular element 17 in the plane of the drawing, however, it is not represented in a sectional view. An open end of the tubular element 17 extends inside the envelope 11,13, and a closed end extends outside the envelope 11,13. Outside the envelope 11,13, the tubular element 17 is curved through an angle of 90°. The tubular element 17 is fixed in the disc-shaped member by means of a thermally insulating adhesive, a layer 19 of said insulating material surrounding the tubular element 17.

The lead wires 14,15 pass through the metal disc-shaped member 13 and the metal cylindrical wall 18 and have to be electrically insulated from both parts. Therefore, each lead wire 14,15 is fixed in a bore in the disc-shaped member 13 and the cylindrical wall 18 by means of a layer 21 of electrically insulating adhesive.

The envelope 11,13 of the lamp is filled with the appropriate gas mixture through the tubular element 17, and afterwards the outer end of the tubular element 17 is closed with solder 20. During operation of the lamp, the outer end of the tubular element 17 will remain relatively cold because of its distance to the envelope 11,13, because of the thermally insulating layer 19, and because of the shield 18 (cylindrical wall) between the electrode and the open end of the tubular element 17. The cold spot of the lamp will be located in the tubular element 17 as a result and will be relatively cold. Heat can be transported away by convection of air around the tubular element 17. Being curved, the relatively long tubular element 17 will not increase the total length of the lamp.

The embodiments of the gas discharge lamp as described above are merely examples; a great many other embodiments are possible.

1. A gas discharge lamp having an envelope (1,3; 11,13) comprising a translucent cylindrical part (1; 11) and an end part (3; 13) at each end of said cylindrical part (1; 11), lead wires (4,5; 14,15) for supplying electric current to an electrode (6; 16) near each of said end parts (3; 13) extending through the material of each of the two end parts (3; 13), characterized in that at least one end part (3; 13) is provided with a tubular element (7; 17) made of a thermally conductive material, such as a metal or a thermally conductive ceramic material, that extends through the material of said end part (3; 13), an open end of said tubular element (7; 17) being connected to the space inside the envelope (1,3; 11,13) while a closed end of the tubular element (7; 17) extends outside the envelope (1,3; 11,13).

2. A gas discharge lamp as claimed in claim 1, characterized in that said tubular element (17) is curved, so that said closed end thereof is positioned at an angle to the axial direction of said cylindrical part (11), preferably an angle of about 90°.

3. A gas discharge lamp as claimed in claim 1, characterized in that a heat sink (8,9) located outside the envelope (1,3) is connected to said tubular element (7).

4. A gas discharge lamp as claimed in claim 1, characterized in that said at least one end part is a disc-shaped member (3; 13), the edge of said disc-shaped member (3; 13) being connected to the circular edge of the translucent cylindrical part (1; 11).

5. A gas discharge lamp as claimed in claim 1, characterized in that a shield (18) is present inside the envelope (11,13) between at least a portion of the electrode (16) and the open end of the tubular element (17), which shield (18) is attached to said end part (13) near the electrode (16).

6. A gas discharge lamp as claimed in claim 6, characterized in that the shield (18) substantially encloses the electrode (16).

7. A gas discharge lamp as claimed in claim 6, characterized in that said shield (18) is made of metal or of ceramic material and is provided with a heat-reflecting surface at its side facing the electrode (16), and/or a surface providing minimal heat radiation at the other side.

8. A gas discharge lamp as claimed in claim 4, characterized in that the material of the disc-shaped member (3; 13) is metal.
